(19) United States
(12) Patent Application Publication
(10) Pub. No.: US 2004/0057172 A1
(43) Pub. Date: Mar. 25, 2004

(54) Circuit for protection against electrostatic discharge

(76) Inventor: Maoyou Sun, Piscataway, NJ (US)

Correspondence Address: JONES DAY, 222 EAST 41ST STREET, NEW YORK, NY, 10017, US

(21) Appl. No.: 10/255,787

(22) Filed: Sep. 25, 2002

(51) Int. Cl. H02H 9/00

(52) U.S. Cl. 361/56

(57) ABSTRACT

A method and system for protecting RF circuits from ESD events are disclosed that unlike traditional diode-train-based ESD protection circuit's high turn-ON voltage, provide various voltage levels for triggering one or more ESD shunt path. The disclosed ESD protection circuit employs one or more small diodes arranged in a series to trigger ON one or more current carrying transistors that once switched ON, conduct high current. The ESD protection circuit rapidly shunts the ESC current thereby reducing the impact of the ESD event upon the protected RF circuit. Furthermore, the disclosed system and method exhibit a reduced parasitic loading effect with the use of small triggering diodes and large current carrying transistors in a diode configuration. The disclosed method and system provide a simple and compact ESD protection circuit capable of providing customized protection against reverse ESD events as well.

### FIELD OF THE INVENTION

The present invention is related in general to providing protection to electrical and electronic devices against electrical discharges and in particular providing radio frequency integrated circuits with reduced parasitic capacitance electrostatic protection circuits suitable for various voltage supply ranges.

### BACKGROUND OF THE INVENTION

Electrostatic Discharge (“ESD”) is a familiar cause of device failure due to catastrophic and latent defects. Catastrophic defects result in rapid failure of the device while latent defects are harder to detect since they affect reliability over continued operation or unfavorable changes to device tolerances. In either event, it is desirable to provide integrated circuits with the ability to withstand expected ESD events. This goal has become ever more significant with the widespread efforts to provide hot-docking that inevitably results in transients and possibly ESD events. However, an ESD protection circuits should not significantly add to the noise level since amplification and detection of extremely weak signals is the primary concern in many RF devices.

In another aspect, the high working frequency or high speed of RF circuits requires the ESD circuit to have low parasitic impedance, which is a significant limitation on ESD circuit design. Moreover, the ESD protection circuit should consume as littel chip area as possible for low cost and high integration of communication systems.

There are many causes for the generation of static electricity resulting in ESD. Familiar causes for generating static electricity include charge separation due to the generation of triboelectricity due to two different materials being rubbed together. When the two materials are placed in contact and then separated, electrons are transferred from the surface of one material to the surface of the other material creating a potential difference. Since the resulting electrostatic discharge upon charge neutralization can be due to a potential of several hundred to several thousand volts, it can easily damage integrated devices with their fragile micron and sub-micron scale structures.

For silicon-based bipolar integrated circuits, the current gain is dependent on the ration of emitter doping to base doping of the transistor. High doping of emitter for high current gain results in a low breakdown voltage of the base-emitter junction. With increasing working frequencies of RF circuits, the newly developed GaAs or InP heterojunction bipolar transistor (HBT) technology presents further challenges due to low breakdown voltages of base-emitter junctions required for high frequencies. Since, the bandgap difference between emitter and base results in the current gain not depending on the upper limit of base doping, the base can be doped heavily to decrease the base resistance and improve high-frequency performance of the device. This, however, results in low breakdown voltages.

Typically, during an electrostatic discharge (ESD) event, a large current pulse is injected into one electrical connection or signal pad of an integrated circuit and extracted from another pad. Often current pulses from such events have peak injected currents that exceed one ampere. For surviving such a pulse without damage, a robust, low impedance shunt path for the current must be available between the affected pads. Damage ascribed to ESD events is primarily due to a large current forced through a device such that more energy/heat is deposited within a short time interval than can be removed resulting in sufficiently high temperatures to result in damage to leads, crystal structure, oxide layers and/or the structural integrity of the integrated circuit. Therefore, preferably, each pad, pin, bus, and the like in an integrated circuit should be connected to a suitable ESD protection circuit.

Electrostatic damage to electronic devices can occur at any point from manufacture to field service. An electronic device exposed to an ESD event may experience either a catastrophic failure, wherein the device's circuitry fails to function as a result of the ESD event; or a latent defect, wherein the device still functions after the ESD event but its operating life is dramatically reduced. Catastrophic failures are relatively easy to confirm via basic performance tests. Latent defects, however, can be extremely difficult and costly to detect using current technology, especially after the device is assembled into a final product. Thus, preventing damage by ESD is of importance in avoiding catastrophic and latent damage by making the devices resistant to the expected ESD exposure.

There are several models developed to analyze the expected ESD discharges in different situations for evaluating device robustness. These models include the human body model, the machine model, and the charged device model. The human body model simulates the effect of human handling on semiconductor devices. The capacitance of the human body is generally chosen to be 100 pf and the series resistance of the human body is usually modeled as 1.5K Ohms. The capacitor C1 is charged to an initial voltage V1, typically of the order of 2 to 3 Kev, and then discharged via the device being tested. The machine model or “zero ohms” model utilizes the a capacitance of 200 pf and the resistance “zero ohms.” The charged device model is used to simulate the ESD failure mechanisms associated with machine handling during the packaging and testing of semiconductor devices by charging an IC package to a potential (100 volts to 2000 volts) by triboelectricity or by the presence of large electric fields followed by a discharge to ground via any of the device pins.

To reduce interference with an integrated circuit's normal operation, an ESD protection circuit generally has both active (ON) and inactive (OFF) states. Under normal operating conditions the ESD protection circuit should stay OFF and turn ON sufficiently rapidly to shunt potentially harmful currents during an ESD event. In particular, the ESD protection circuit in its OFF state should not add excessive resistive or capacitive load for the integrated circuit so that it functions essentially independent of the implementation of the ESD protection circuit. In agreement with such goals, the ESD protection circuit should not have substantial OFF-state leakage, or require extensive area on the integrated circuit for its implementation.

It is also desirable that the ESD circuit consume little power, if any, from buses except when shunting a current due to an ESD event. Since, functional applications of an integrated circuit require direct connections of input or output (I/O) terminal pads to one or more external buses that may carry active signals even when power is not applied to the integrated circuit, ESD protection circuitry must not interfere with the operation of such buses. The directly connected I/O pads must not draw excessive current when a bus signal is pulled high and because the buses may carry active signals even when power to an integrated circuit with one or more I/O pads directly connected to the bus is OFF, the protection circuitry must maintain a high trigger voltage that is independent of the supply voltage in power-OFF conditions.

The high speed and short response time required of RF devices require that the impedance (including that due to parasitic impedances and capacitances) due to any built-in protection against ESD should not adversely affect the time constant for responding to an input. Typically, ESD protection is provided for overages between the supply pads and/or pins and the ground, between the I/O pads and/or pins and either the ground or the supply. Furthermore, in view of the limited power consumption required in handheld RF devices and RF devices in general, it is imperative that the ESD protection circuit consume little power, while responding sufficiently fast to direct away ESD prior to any actual damage to the device.

Despite a great deal of effort during the past decade, ESD continues to affect production yields, manufacturing costs, product quality, reliability and profitability. Industry experts have estimated average product losses due to ESD range from 8-33%. Others estimate the actual cost of ESD damage to the electronic industry as running into the billions of dollars annually. Furthermore, most of the existing literature on ESD protection primarily focuses on a particular circuit rather than a general method/design for protecting against ESD any set of points comprising pads, pins, buses, terminals, and the like. Since presently most RF circuits, particularly those based on GaAs-based and other newer technologies, have either no ESD protection, or rely upon a simple diode chain for ESD protection, it is desirable to develop a wide variety of techniques for providing ESD protection.

### SUMMARY OF THE INVENTION

One aspect of the present invention comprises a novel electronic circuit for protecting RF circuits from ESD events. Traditional diode-train-based ESD protection circuits have high turn-ON voltage for conducting large currents associated with ESD events. In contrast, the disclosed ESD protection circuit provides smaller turn-ON voltage by employing small diodes arranged in a series to trigger ON one or more current carrying transistors for a better response to ESD events. The transistors, once switched ON, conduct high current while maintaining a low voltage drop from the collector to the emitter. When connected in parallel with the protected RF circuit, the ESD protection circuit rapidly shunts the ESD current thereby reducing the impact of the ESD event upon the RF circuit.

In another aspect, the parasitic loading effect due to the ESD circuit is reduced by the small triggering diodes and the large current carrying transistors that actually carry the ESD current. Thus, with suitably chosen triggering diodes the transistors are not switched ON during normal operations. The combination of small triggering diodes and the current carrying transistors has a lower parasitic capacitance resulting in a reduced parasitic loading effect on the protected RF circuit.

Another aspect of the present invention is to provide a simple and compact ESD protection circuit. The present ESD protection circuit is simple because only diodes and transistors are used in the circuit. Comparing to traditional ESD protection circuits composed of a large number of big diodes in series, the present ESD protection circuit requires less space because it only uses fewer and smaller diodes and transistors.

### BRIEF DESCRIPTION OF DRAWINGS

These and other features, aspects and advantages of the presentation invention will become better understood with regard to the following descriptions, appended claims and accompanying drawing in which:

FIG. 1 illustrates an embodiment of the present invention.

FIG. 2 illustrates another embodiment of the present invention.

FIG. 3 illustrates another embodiment of the present invention with another resistor in the reverse ESD direction.

FIG. 4 illustrates another embodiment of the present invention without resistors connected between the base and the emitter of the triggering transistor.

FIG. 5 illustrates another alternative circuit embodiment wherein different number of diodes and transistors in diode configuration are used.

FIG. 6 illustrates another alternative embodiment wherein one of the diodes in series is replaced by a small transistor.

FIG. 7(a) illustrates the relationship between transient conducting current and voltage property for FIG. 1's circuit when voltage is applied to point 32 of FIG. 1's circuit with point 34 is grounded.

FIG. 7(b) illustrates the time course of the transient voltage at point 32 for FIG. 1's circuit when voltage is applied to point 32 of FIG. 1's circuit with point 34 grounded.

FIG. 8(a) illustrates the relationship between the transient conducting current and the voltage for FIG. 1's circuit when voltage is applied to point 34 of FIG. 1's circuit with point 32 grounded.

FIG. 8(b) illustrates the time course of the transient voltage at point 34 for FIG. 1's circuit when voltage is applied to point 34 of FIG. 1's circuit with point 32 grounded.

FIG. 9(a) illustrates the relationship between the extracted shunt resistance and the frequency for FIG. 1's circuit.

FIG. 9(b) illustrates the relationship between the extracted shunt capacitance and the frequency for FIG. 1's circuit.

FIG. 10 is an illustration of the arrangement of FIG. 1 in an example application circuit.

FIG. 11 illustrates an additional embodiment of the present invention employing small diodes and big transistors in parallel.

### DETAILED DESCRIPTION OF THE INVENTION

The invention encompasses embodiments for protecting buses, pads, pins, and the like from thermal damage from excessive energy deposition due to high current flow by providing a shunt pathway that is activated in response to a threshold voltage being exceeded between two protected points. The threshold voltage for current flow in one direction between two points may be different from the threshold for a current flow in the reverse direction. Moreover, the protection is suitable for integrated devices manufactured by a variety of technologies such as RF integrated chips based on GaAs processes as well as silicon-based processes. The described method and system are useful for providing protection against various types of Electrostatic Discharges (“ESD”) in integrated circuits, including one or more integrated circuits modules mounted on a printed circuit board.

Without being bound by any theory, the operation of the described embodiments is believed to be as described herein. Additional details and more sophisticated analysis may be introduced in alternative treatments without affecting the outcome of the operation of the invention.

An embodiment of the present invention comprises an integrated circuit having an ESD protection circuit providing a shunt path between two or more points in response to the application of a voltage exceeding a threshold across the two points. Each of the two points typically, but not as a requirement, samples the potential at a pad, a bus, a pin, or a location in an integrated circuit with similar meanings in the context of a printed circuit/simulation. The term “point” is intended to encompass a site in an integrated circuit, pads, or simply pins of the integrated circuit, such as one or more pins for receiving power, providing a ground, or data input/output. The ESD protection circuit comprises at least one triggering transistor connected between a first point and a second point via a first contact and a second contact respectively. This connection need not be direct and additional elements, such as a resistance, including parasitic resistance/impedance, or a diode, may be interposed between the first contact and the first point in alternative embodiments of the invention.

The triggering transistor can, in general, be any type of transistor although preferably it is a bipolar junction transistor (BJT). In a preferred embodiment, the first and the second contact for a BJT are the collector and the emitter or vice versa with the control input of triggering transistor being the base. This triggering transistor is turned ON by a voltage dividing serial arrangement comprising at least one diode with the voltage dividing serial arrangement connected between the first and second points.

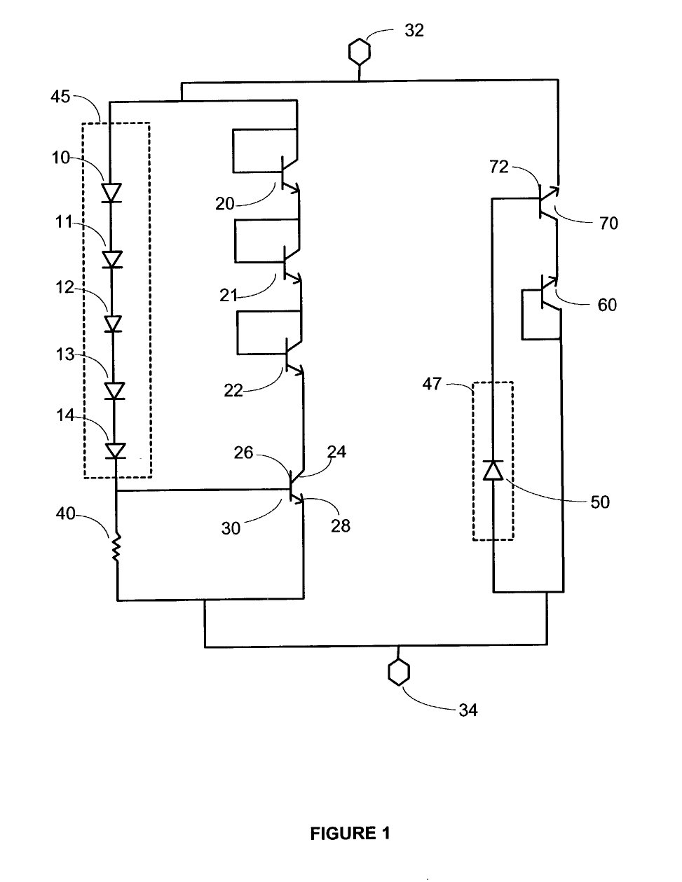

As shown in FIG. 1, a plurality of diodes, e.g., diodes 10-14 respectively, are connected in series between point 32 and point 34 as part of voltage dividing serial arrangement 45, which also includes resistance 40 connected between base 26 and emitter 28 of the triggering BJT 30. Furthermore, in FIG. 1 three transistors, transistors 20-22 respectively, each in diode configuration, are connected in series between collector 24 of the triggering transistor 30 and point 32. It should be noted that in alternative embodiments one or more diodes may be used to replace transistors 20-22, although such replacement may result in additional parasitic capacitance. It should also be noted that each of these transistors can be made of several transistors in parallel to protect against higher ESD current.

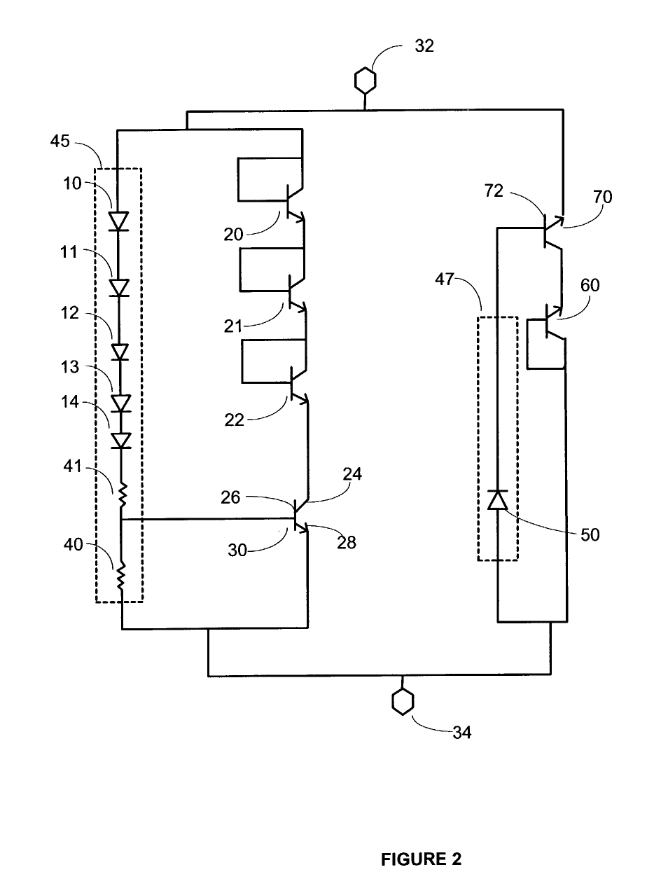

FIGS. 1 and 2 also show some example voltage dividing serial arrangements. Since point 32 is connected to high voltage node and point 34 is connected to low voltage node, the use of multiple diodes specifies the forward threshold voltage for triggering the BJT. Resistor 40 connecting to point 34 keeps triggering transistor 30 OFF under normal working conditions. Resistor 40 also influences the duration of switch-OFF time of triggering transistor during an ESD event.

For reverse ESD events, preferably one diode is used to specify the reverse threshold voltage for triggering transistor 70. Since during normal operation, voltage at point 32 is higher than the voltage at point 34, triggering transistor 70 does not turn ON in the reverse path. Usually, although not as a requirement, no resistor is placed between point 32 and point 72, so that the peaking voltage under forward ESD event is applied to two diodes rather than just one diode to protect diode 50 from excessive forward ESD voltages. Since the base-collector junction of transistor 70 may break down before the forward path has discharged the energy of the forward ESD event, at least one transistor in diode configuration 60 is connected in series between the collector of triggering transistor 70 and point 34. This decreases the shunt capacitance and increases the breakdown voltage of the ESD circuit for forward ESD voltages because the voltage drop across the base collector junction of triggering transistor 70 is shared by the series transistors in diode configuration. The triggering transistor 70 and the transistors in diode configuration are large transistors that can conduct the ESD current.

The use of multiple diodes in conjunction with one or more resistors enables use of a well-defined reference voltage for triggering the BJT. Preferably, at least one diode is connected across the base and collector of the triggering transistor, although more diodes may be deployed as shown in FIGS. 1 and 2. Moreover, at least one transistor in diode configuration is connected in series between the collector of the triggering transistor and the first point. Of course, more than one transistors in diode configuration may be connected between the collector of the triggering transistor and the first point. The triggering transistor may be a large transistor that can conduct the ESD current by itself. Alternative embodiments may split the ESD current into multiple shunt paths each comprising smaller triggering transistors.

Returning to FIG. 1, in response to a voltage between points 32 and 34 sufficient to forward bias diodes 10-14 in voltage dividing serial arrangement 45, a voltage drop is created across resistor 40 resulting in activating triggering transistor 30. The flow of current through the triggering BJT 30 provides a low impedance path that shunts sufficient current to avoid damage due to excessive heating. Since diodes 10-14 in voltage dividing serial arrangement 45 are used to turn ON the transistor while the transistors 20-22 actually carry most of the current, diodes 10-14 can be reduced in size with concomitant reduction in their parasitic capacitance. Transistors 20-22 designed to carry most of the ESD current, have significantly lower parasitic capacitances than comparable diodes resulting in lower overall capacitance ascribable to the ESD protection circuit, which is important for RF integrated circuit operation. The integrated circuit with the ESD protection circuit has a equivalent parasitic shunt capacitance that is less than a capacitance selected from the group consisting of 3 pF, 2 pF, 1 pF, 0.5 pF, 0.3 pF, 0.2 pF, and 0.1 pF. Preferably, the equivalent parasitic capacitance is less than 0.2 pF. The integrated circuit with the ESD protection circuit has a equivalent shunt resistance that is larger than a resistance selected from the group consisting of 10000 Ohms, 4000 Ohms, 3000 Ohms, 2000 Ohms, 1000 Ohms, 500 Ohms, 300 Ohms, and 100 Ohms. Preferably, the equivalent shunt resistance is 500 Ohms.

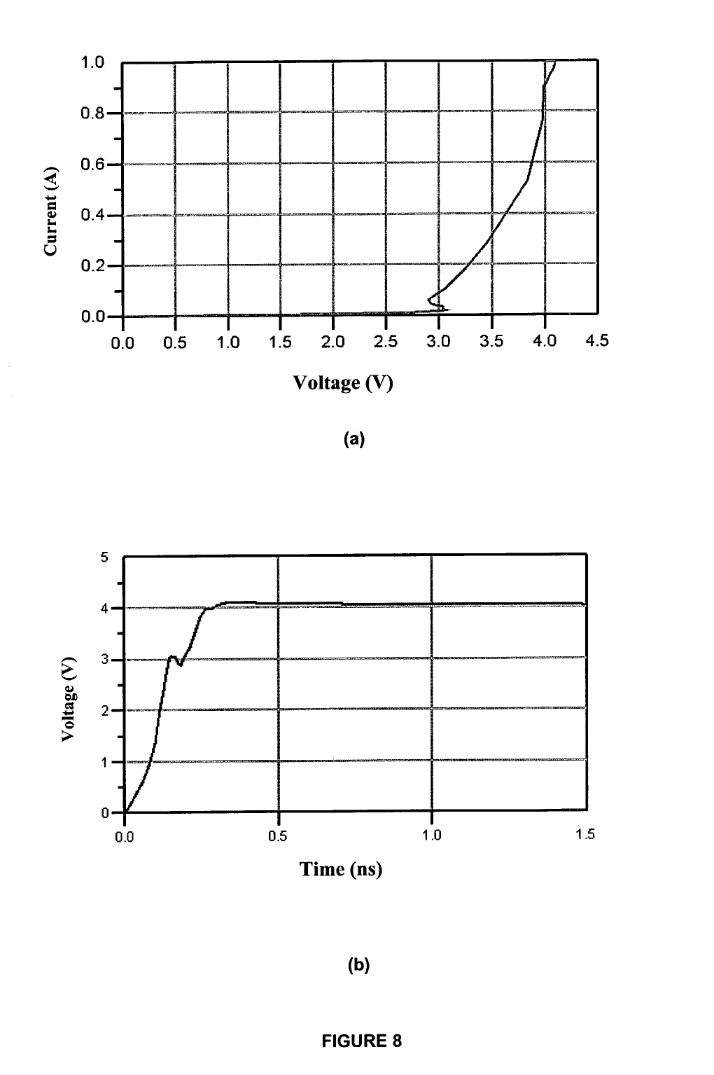

The use of diodes, triggering transistors and transistors configured as diodes results in a fast response to an ESD event and with a lower peaking voltage. Preferably, the ESD protection circuit has at least one triggering transistor with a base receiving the control input, a collector receiving the first connection and an emitter receiving the second connection. In the an embodiment of the invention, the triggering transistor is turned ON in less than 0.2 nanosecond, as shown in FIG. 8(b). The relationship between transient conducting current and voltage for the abovementioned embodiment is shown in FIG. 8(a).

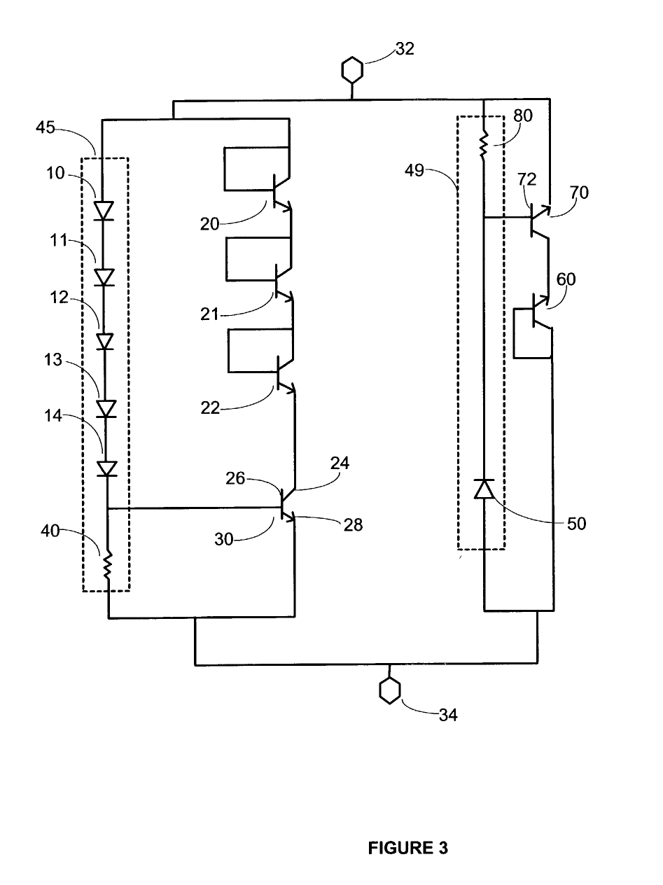

In another aspect, the ESD protection circuit preferably has second triggering transistor 50 connected between points 32 and 34 to protect against an ESD discharge due to a negative voltage. Voltage dividing serial arrangement 47 connected to the base of this second triggering transistor allows setting of an independent threshold for the triggering transistor. FIG. 1 illustrates such an asymmetric arrangement. Using one or more transistors, e.g., transistor 60, in diode configuration connected in series to the collector of the second triggering transistor reduces the parasitic capacitance while small diode 50 in voltage dividing serial arrangement 47 provides a desired triggering voltage reference. It should be noted that the various voltage dividing serial arrangements need not always connect between the two particular points protected by the ESD circuit. Instead, the voltage to trigger the transistor may be provided by an arrangement connected only to the base of the triggering transistor as illustrated in FIG. 1. An alternative exemplary embodiment with an additional resistor in the reversed direction voltage dividing serial arrangement is shown in FIG. 3.

The low parasitic capacitance of the order of 1.5 pF or less enabled by the disclosed system and method results in robust RF performance. Preferably, the extracted shunt capacitance of the ESD protection circuit is in the range between 0.1 pF and 0.15 pF. The response time of such an ESD protection circuit is less than a nanosecond and preferably less than 0.15 nanosecond following an ESD event.

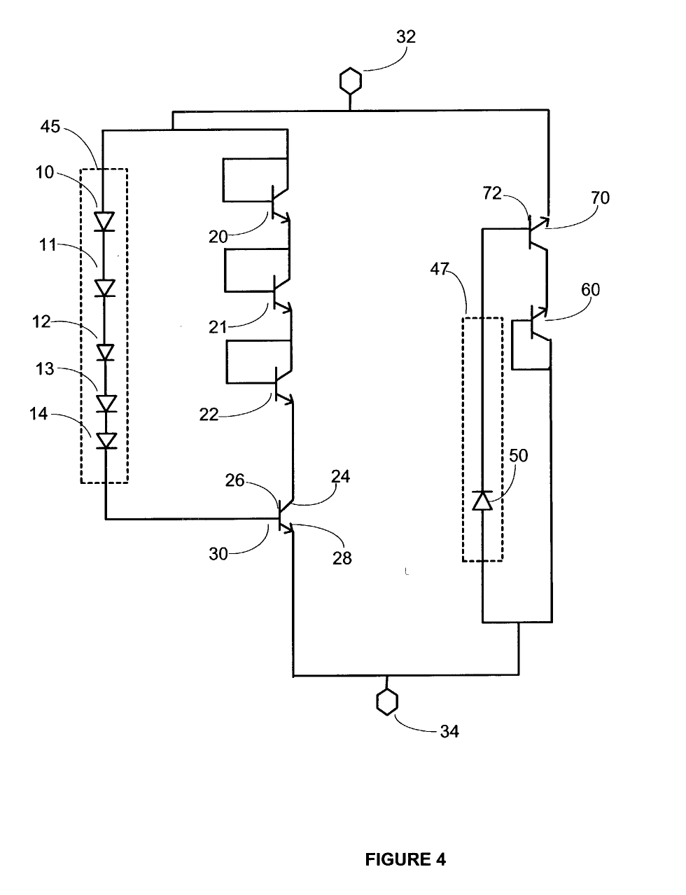

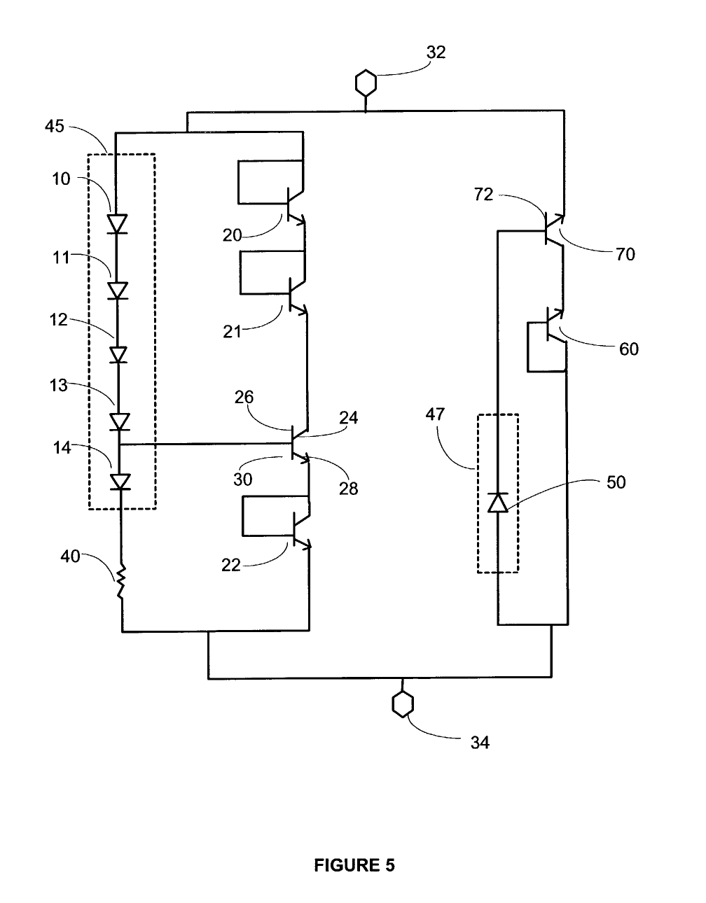

Some exemplary alternative embodiments of the disclosed ESD protection circuit are shown in FIGS. 2-7. The embodiment in FIG. 2 contains additional resistor 41 connected between diode 14 and the base 26 of the triggering transistor. The embodiment in FIG. 3 also contains additional resistor 80 connected between point 32 and the base 72 of triggering transistor 70. The presence of resistor 80 introduces a voltage drop between base 72 and point 32 upon the occurrence of a reverse ESD event between point 34 to point 32. The triggering transistor 70 is then turned-ON following the voltage drop. FIG. 4 shows an alternative ESD protection circuit without resistor 40. In this alternative circuit the triggering transistor 30 is turned-ON by the voltage drop from the series of diodes 10-14. FIG. 5 shows another alternative circuit embodiment wherein 4 diodes 10-13 in series are connected between point 32 and base 26 of the triggering transistor 30 and 2 transistors in diode configuration 20-21 are connected between point 32 and collector 24.

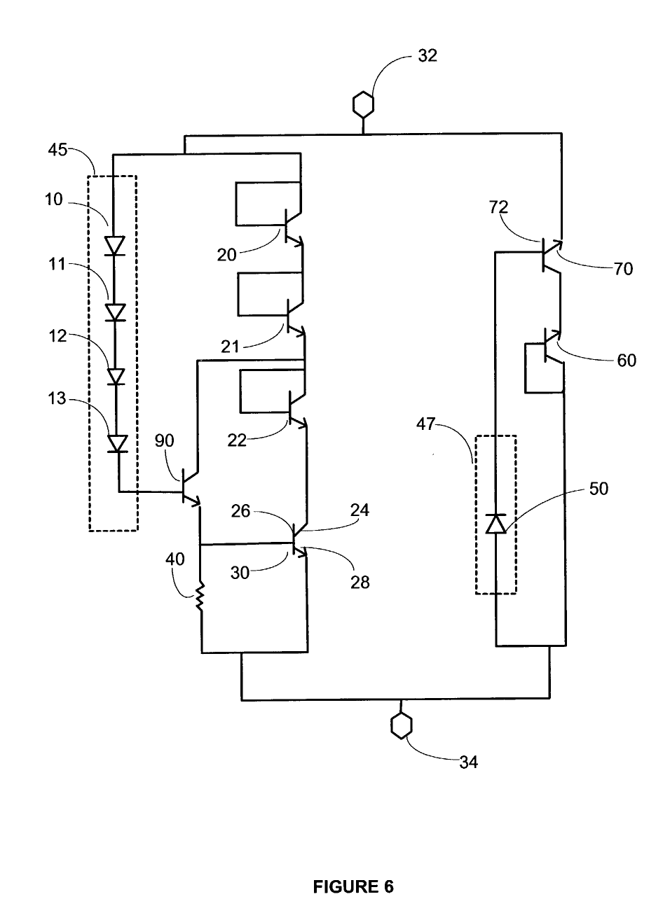

FIG. 6 shows another alternative embodiment wherein small transistor 90 replacing diode 14 is used. Small transistor 90, together with triggering transistor 30, results in more flowing through transistor shunt path over diode chain 45 comprising diodes 10-13. Specifically, with little current flowing into the base of transistor 90, a larger current is shunted through the triggering transistor 30 and transistors in diode configuration in series 20-22. As a result, the a faster response to ESD event is achieved than in the circuit illustrated in FIG. 1 with smaller diodes 10-13 resulting in smaller chip size while providing sufficient ESD protection.

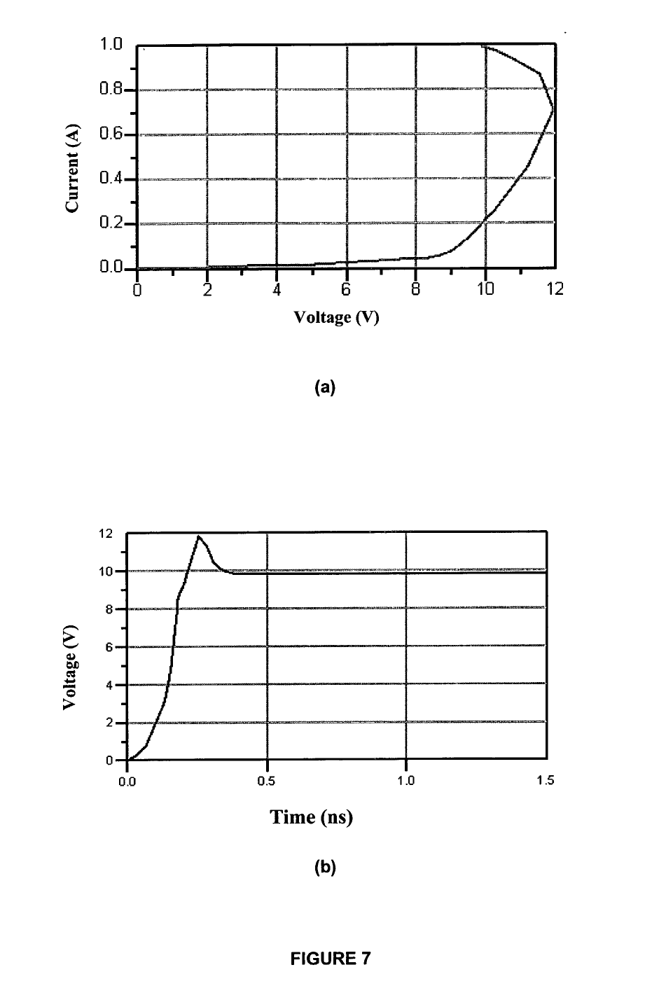

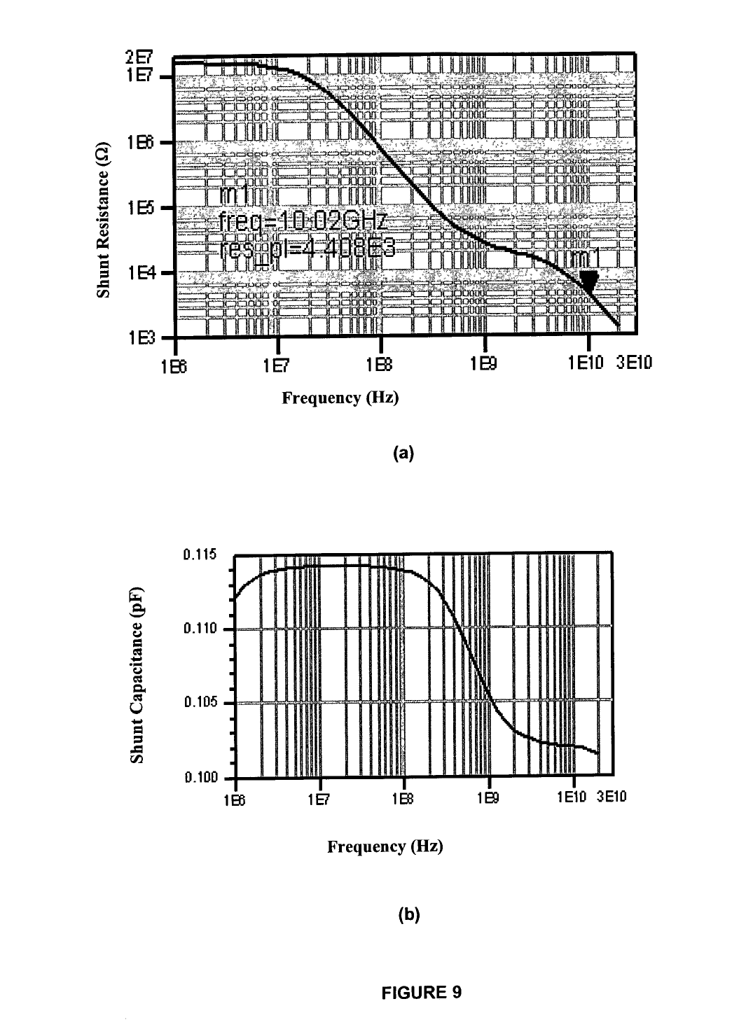

FIGS. 7-9 shows the performance of the circuit of FIG. 1 in response to the occurrence of an ESD event resulting in a current discharge between point 32 and point 34. FIG. 7(a) shows the transient conducting current vs. voltage property of the embodiment. We can see from the figure that the transient ESD voltage between point 32 and point 34 peaks at about 12 volt right after the ESD event and then stabilizes at the normal operating voltage of 10 voltage. From transient voltage vs. time graph shown in FIG. 7(b), we can see that the triggering transistor is turned ON in less than 0.2 nanosecond as the transient voltage reaches its peak. FIG. 8(a) and 8(b) shows the transient performance of the same circuit upon a reverse ESD event from point 34 to point 32. It is shown that the FIG. 1 circuit responded within 0.25 nanosecond with a peak voltage of less than 4 volt. FIGS. 9(a) and 9(b) shows the shunt-resistence and shunt-capacitance of the FIG. 1 circuit vs. frequency illustrating a reduced shunt resistence and shunt capacitance with an increasing frequency. For instance, FIG. 9(a) shows the lower shunt resistance of 4408 Ω at 10.02 Ghz, while FIG. 9(b) shows that the shunt capacitance is reduced to 0.102 pF at 10 GHz.

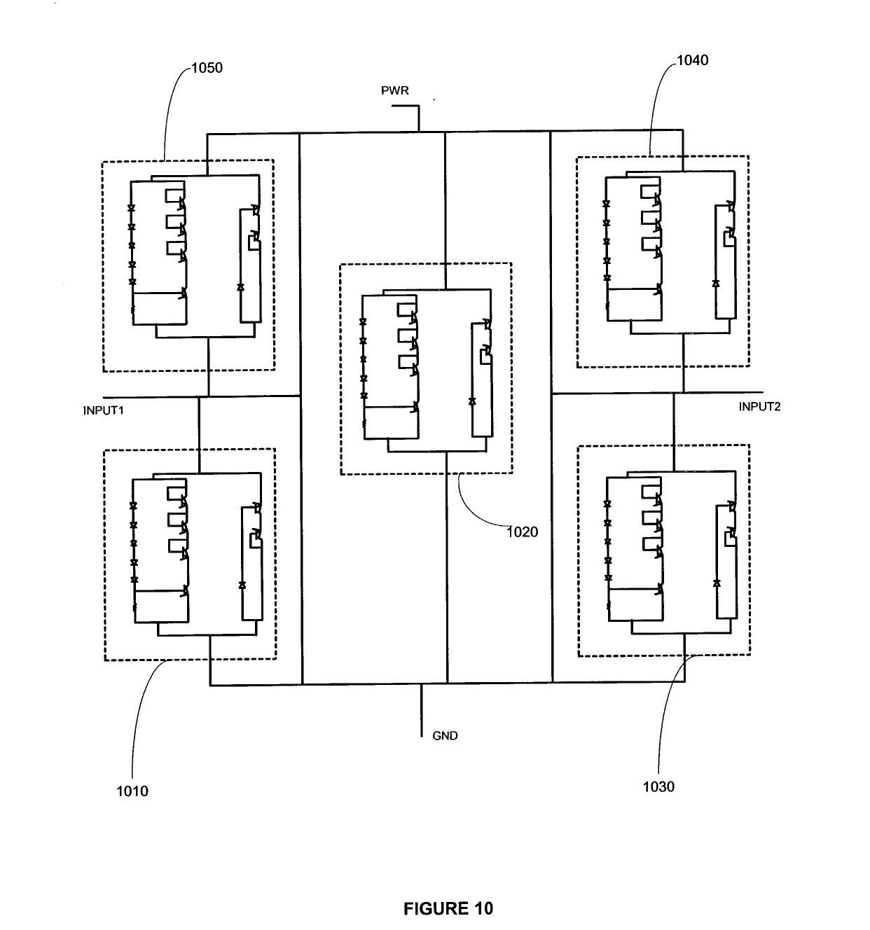

In a typical implementation, multiple points on the same IC may be protected by ESD protections circuits. For instance, an implementation of the disclosed ESD protection circuit from FIG. 1 is shown in FIG. 10 with 5 ESD protection circuits 1010, 1020, 1030, 1040, 1050 implemented between various points of an IC to protect pads and buses of interest.

### EXAMPLES

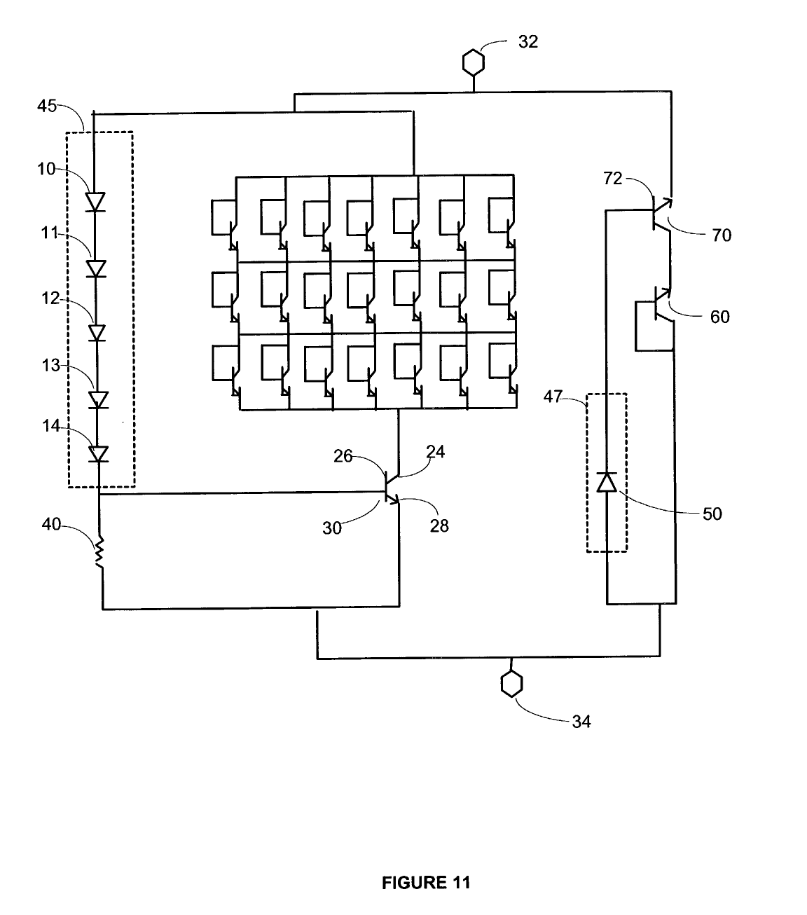

FIG. 11 illustrates an additional embodiment of the present invention employing small diodes and big transistors in parallel. Each of these diodes has an emitter area of about 4.2 square microns. The triggering transistor and each of the transistors in diode configuration in FIG. 11 can be made of big transistors in parallel. The number of big transistors in parallel can be 7, 14, or any. FIG. 11 shows an embodiment with 7 big transistors in parallel. Each of these big transistors has an emitter area of about 12 square microns. As indicated before, introducing transistors in parallel can protect the IC against higher ESD current.

Experiments show that at 10 GHz, FIG. 11's circuit demonstrates a shunt resistance of approximately 470 Ω and a shunt capacitance of approximately 0.2 pF. An alternative embodiment having 14 big transistors in parallel demonstrates a shunt resistance of approximately 140 Ω and a shunt capacitance of approximately 0.3 pF at 10 GHz.

FIG. 11's circuit can protect against forward ESD voltage of as much as 2700 volts and reverse ESD voltage of as much as 2900 volts. If the expected forward ESD level is 1000 volts, then the size of the large transistors for the forward ESD protection can be reduced by half or smaller. The shunt capacitance is then reduced to approximately 0.1 pf and shunt resistance increased to approximately 1000 Ω. An alternative embodiment having 14 big transistors in parallel can protect against forward and reversed ESD voltages of up to 5000 volts.

### CONCLUSION

The disclosed invention also encompasses methods for providing ESD protection comprising the steps of fabricating at least one triggering transistor connected between points protected against ESD (each of the protected points may be a pad, bus, or pin) and a voltage dividing serial arrangement comprising at least one diode, which may be a small transistor in diode configuration, connected between the points to trigger the at least one triggering transistor. Additional larger transistors in diode configuration or diodes may be connected in series to the triggering transistor. The triggering transistor may also have at least one control input, for instance, the base of the triggering transistor for a BJT, in which case the collector and the emitter of the BJT triggering transistor are connected directly or indirectly to the protected points.

Another embodiment may further comprise fabricating a plurality of transistors in diode configuration connected in series between the first connection to the at least one triggering transistor and the first point. The number of transistors in diode configuration should be less than the number of diodes (or small transistors in diode configuration) in series, and preferably, but not as a requirement, is two less than the number of diodes in series. This results in overall reduction in area required for providing ESD protection, lower parasitic capacitance and fast response to an ESD event due to the small diodes used to trigger the triggering transistor. For adequate current carrying capacity, the triggering transistor and the transistors in diode configuration in series with it need large emitter areas. Some exemplary areas may be selected from the group (or any subgroup thereof) consisting of about 30 μm² or less, about 25 μm² or less, about 20 μm² or less, about 15 μm² or less, about 12 μm² or less, and about 10 μm² or less. Similarly, the diodes (or small transistors in diode configuration) in the voltage dividing arrangement have small areas such as those selected from the group (or any subgroup thereof) consisting of about 5 μm² or less, about 4.5 μm² or less, about 4.2 μm² or less, about 4 μm² or less, about 3.5 μm² or less, and about 3 μm² or less.

Yet another embodiment of the above method may further comprise the step of fabricating a plurality of diodes connected in series between the first point and the second point as part of the first voltage dividing serial arrangement. The number of diodes in series is determined by the power supply voltage and the turn-on voltage of PN junction. The preferable number is five in the illustrated embodiments, but many other numbers are acceptable.

By way of explanation it is believed that for InGaP HBT, since the typical power supply is 5.2V and the PN junction turn-ON voltage is 1.2V, as desired during normal operations, 5 diodes in series will not turn ON the ESD protection circuit while an ESD event of interest will be sufficient to turn them ON. Similarly for silicon-based BJT, the typical power supply voltage is 3.3V and the PN junction turn-ON voltage is 0.7V.

It will be appreciated that the various features described herein may be used singly or in any combination thereof. Thus, the present invention is not limited to only the embodiments specifically described herein. While the foregoing description and drawings represent an embodiment of the present invention, it will be understood that various additions, modifications, and substitutions may be made therein without departing from the spirit and scope of the present invention as defined in the accompanying claims. In particular, it will be clear to those skilled in the art that the present invention may be embodied in other specific forms, structures, and arrangements, and with other elements, and components, without departing from the spirit or essential characteristics thereof. One having ordinary skill in the art will appreciate that the invention may be used with many modifications of structure, arrangement, and components and otherwise, used in the practice of the invention, which are particularly adapted to specific environments and operative requirements without departing from the principles of the present invention. The presently disclosed embodiment is therefore to be considered in all respects as illustrative and not restrictive, the scope of the invention being indicated by the appended claims, and not limited to the foregoing description.

What is claimed is:

1. An ESD protection circuit for providing a shunt path triggered by a voltage spike between a first and a second point, the ESD protection circuit comprising:
at least one triggering transistor connected between the first and second points via a first connection and a second connection respectively;
a first voltage dividing serial arrangement comprising at least one diode connected between the first and second points, wherein furthermore, the at least one diode is connected across the first connection to the triggering transistor and a control input to triggering transistor; and
at least one transistor in diode configuration connected in series between the first connection to the triggering transistor and the first point.

2. The ESD protection circuit of claim 1 wherein the at least one triggering transistor is a bipolar transistor with a base receiving the control input, a collector receiving the first connection and an emitter receiving the second connection.

3. The ESD protection circuit of claim 1 wherein the first and second points are a part of an integrated circuit.

4. The ESD protection circuit of claim 1, further comprising a plurality of transistors in diode configuration connected in series between the first connection to the triggering transistor and the first point.

5. The ESD protection circuit of claim 4 wherein three transistors in diode configuration are connected in series between the first connection to the triggering transistor and the first point.

6. The ESD protection circuit of claim 1, further comprising a plurality of diodes connected in series between the first point and the second point as part of the first voltage dividing serial arrangement.

7. The ESD protection circuit of claim 6 wherein the first voltage dividing serial arrangement further comprises at least one resistance in addition to the plurality of diodes connected in series between the first point and the second point.

8. The ESD protection circuit of claim 1 wherein an equivalent parasitic shunt capacitance is less than a capacitance selected from the group consisting of 3 pF, 2 pF, 1 pF, 0.5 pF, 0.3 pF, 0.2 pF, 0.1 pF.

9. The ESD protection circuit of claim 1 wherein an equivalent shunt capacitance is less than 1.5 pF.

10. The ESD protection circuit of claim 1 wherein an equivalent shunt resistance is larger than a resistance selected from the group consisting of 10000 Ohms, 4000 Ohms, 3000 Ohms, 2000 Ohms, 1500 Ohms, 1000 Ohms, and 500 Ohms.

11. The ESD protection circuit of claim 1 wherein an equivalent shunt resistance is less than 1000 Ohms.

12. The ESD protection circuit of claim 1 wherein the at least one triggering transistor is a bipolar transistor.

13. The ESD protection circuit of claim 1, further comprising a second triggering transistor connected between the first and second input points via a third connection and a fourth connection respectively, wherein furthermore, the second triggering transistor has a second control input connected to a second voltage dividing serial arrangement connected between the first and the second points.

14. The ESD protection circuit of claim 13, further comprising at least one transistor in diode configuration connected in series between the fourth connection to the second triggering transistor and the second point.

15. The ESD protection circuit of claim 13, further comprising a plurality of diodes connected in series between the first point and the second point as part of the second voltage dividing serial arrangement.

16. The ESD protection circuit of claim 14, further comprising a diode connected in series between the first point and the second point as part of the second voltage dividing serial arrangement.

17. The ESD protection circuit of claim 13, further comprising a diode connected in series between the second point and the second control input.

18. The ESD protection circuit of claim 1, further comprising at least one additional circuit for processing a RF signal.

19. The ESD protection circuit of claim 1, wherein the number of transistors in diode configurations connected in series between the first connection to the triggering transistor and the first point is less than the number of diodes in the first voltage dividing serial arrangement.

20. The ESD protection circuit of claim 1, wherein at least one of the diodes in the first voltage dividing serial arrangement has an area selected from the group consisting of about 5 μm² or less, about 4.5 μm² or less, about 4.2 μm² or less, about 4 μm² or less, about 3.5 μm² or less, and about 3 μm² or less.

21. The ESD protection circuit of claim 1, wherein at least one transistor in diode configuration has an emitter area selected from the group consisting of about 30 μm² or less, about 25 μm² or less, about 20 μm² or less, about 15 μm² or less, about 12 μm² or less, and about 10 μm² or less.

22. A method of providing protection in an integrated circuit comprising a first point and a second point against electrostatic discharge between the first and the second points, the method comprising:
fabricating at least one triggering transistor connected between the first and second input points via a first connection and a second connection respectively, wherein furthermore, the at least one triggering transistor having a control input;
fabricating a first voltage dividing serial arrangement comprising at least one diode connected between the first and second point, wherein furthermore, the at least one diode is connected across the first connection to the triggering transistor and the control input to triggering transistor; and
fabricating at least one transistor in diode configuration connected in series between the first connection to the triggering transistor and the first point.

23. The method of claim 22 further comprising fabricating a plurality of transistors in diode configuration connected in series between the first connection to the at least one triggering transistor and the first point.

24. The method of claim 23 wherein three transistors in diode configuration are connected in series between the first connection to the triggering transistor and the first point.

25. The method of claim 22 further comprising fabricating a plurality of diodes connected in series between the first point and the second point as part of the first voltage dividing serial arrangement.
